(19) United States
(12) Patent Application Publication
(10) Pub. No.: US 2019/0094402 A1
(43) Pub. Date: Mar. 28, 2019

(54) TEMPERATURE COMPENSATED PARABOLIC SKEW ESTIMATION FOR CLOCKS ON AN AUTONOMOUS SEISMIC NODE

(71) Applicant: Seabed Geosolutions B.V., Leidschendam (NL)

(72) Inventors: Timothy John Bunting, Brighton (GB); Bjarne Isfeldt, Mathopen (NO)

(73) Assignee: Seabed Geosolutions B.V., Leidschendam (NL)

(21) Appl. No.: 16/141,366

(22) Filed: Sep. 25, 2018

Related U.S. Application Data
(60) Provisional application No. 62/562,932, filed on Sep. 25, 2017.

(51) Int. Cl. G01V 1/38; G06F 1/10

(52) U.S. Cl. CPC G01V 1/3852; G01V 2200/12; G06F 1/10

(57) ABSTRACT

Disclosed is a method for determining skew measurements for clock errors in an autonomous seismic node. A parabolic fit may be used to estimate the clock drift of an ocean bottom seismic node during node deployment. A temperature and/or frequency trend and a real-time temperature measurement may be used to compute a temperature corrected parabolic trend. The temperature and/or frequency trend may be measured in a laboratory on a node by node basis or it may be a single trend that is suitable for all nodes. The method may include measuring clock skew prior to node deployment and after node recovery, correcting the pre and post deployment skew measurements based on a temperature and/or frequency trend and/or to a constant reference temperature, and/or computing a parabolic trend of the skew measurements of the clock based on the temperature corrected pre and post deployment skew measurements.

### PRIORITY

This application claims priority to U.S. provisional patent application No. 62/562,932, filed on Sep. 25, 2017, the entire contents of which is incorporated herein by reference.

### BACKGROUND OF THE INVENTION

### Field of the Invention

This invention relates to the modeling and/or correction of clock timing skews, and in particular for determining a parabolic fit for a clock skew of an autonomous seismic node at a variety of temperatures.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. For OBC systems, a cable is placed on the seabed by a surface vessel and may include a large number of seismic sensors, typically connected every 25 or 50 meters into the cable. The cable provides support to the sensors, and acts as a transmission medium for power to the sensors and data received from the sensors. One such commercial system is offered by Sercel under the name SeaRay®. Regarding OBN systems, and as compared to seismic streamers and OBC systems, OBN systems have nodes that are discrete, autonomous units (no direct connection to other nodes or to the marine vessel) where data is stored and recorded during a seismic survey. One such OBN system is offered by the Applicant under the name MANTA®. For OBN systems, seismic data recorders are placed directly on the ocean bottom by a variety of mechanisms, including by the use of one or more of Autonomous Underwater Vehicles (AUVs), Remotely Operated Vehicles (ROVs), by dropping or diving from a surface or subsurface vessel, or by attaching autonomous nodes to a cable that is deployed behind a marine vessel.

Autonomous ocean bottom nodes are independent seismometers, and in a typical application they are self-contained units comprising a housing, frame, skeleton, or shell that includes various internal components such as one or more seismic sensors (e.g., geophone and hydrophone sensors), a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art. See, e.g., U.S. Pat. No. 9,523,780 (citing patents and publications), incorporated herein by reference. Still further, the autonomous seismic nodes may be integrated with an AUV such that the AUV, at some point subsea, may either travel to or from the seabed at a predetermined position. See, e.g., U.S. Pat. No. 9,090,319, incorporated herein by reference. In general, the basic structure and operation of an autonomous seismic node and a seismic AUV is well known to those of ordinary skill.

As with all seismic acquisition systems, the ocean bottom nodes must accurately know the time of each individual recorded amplitude measurement and rely on an accurate time reference to time-tag each recorded sample. This is typically done through an atomic clock or crystal oscillator within the seismic node itself which drives the digitizer of the seismic node and implicitly time-tags each seismic sample. For example, a crystal oscillator is designed to oscillate at a pre-described frequency and provides a relative reference of the time of each sample during the deployment period of the ocean bottom node. The sample number dictates the relative time of each sample. In general, the time-tagging in conjunction with the seismic shot time is used to extract each shot record from the continuous data stream. Due to the environment of an ocean bottom node, the node can traditionally only synchronize with GPS time immediately prior to deployment (e.g., while on board a surface vessel) and immediately after recovery (e.g., after being recovered on a surface vessel). While deployed on the seafloor the seismic node is reliant on the self-contained clock. However, errors in the clock oscillation frequency (i.e., differences from nominal frequency) integrate over the deployment period. This clock drift (i.e., timing error) increases with deployment time and over long deployments needs to be corrected for and/or taken into account.

For ocean bottom node surveys, it is accepted practice to estimate this drift and compensate for it post acquisition (e.g., after the seismic nodes have been recovered and the seismic survey completed). In one such conventional method, reference measurements for each node clock, which are taken pre-deployment and post-recovery of the node, are used to estimate the drift (or skew measurements) over the dive period of the node. Traditionally, linear fits are used to estimate the clock drift by modeling and/or fitting a trend to the skew measurements. The trend is then used to compute the skew at any time during deployment. However, crystal clocks do not drift in a linear manner, and an assumption of a linear fit will not optimally model the skew. Further, temperature of the node at the water surface (e.g., on the back deck of the vessel) is significantly differently than a temperature on the bottom of the ocean; because the temperature has an effect on the clock drift/frequency of the clock, a non-constant temperature over the deployment period makes it hard to determine a fit for the clock drift. This temperature dependence may be mitigated through a number of methods which include cutting the crystals to minimize dependence on temperature, wrapping the crystal in an oven to help regulate the temperature, and making real-time corrections to the oscillation frequency (through voltage control) based on real-time temperature measurements.

The statements in this section are intended to provide background information related to the invention disclosed and claimed herein. Such information may or may not constitute prior art. It will be appreciated from the foregoing, however, that there remains a need for an improved method and system for modeling clock drift for autonomous seismic nodes. A need exists for an improved method and system for modeling clock drift during applications where temperature varies during use of the clock. A need exists for an improved method and system for modeling clock drift using a parabolic fit. This need exists not only in ocean bottom seismology but in other applications where there is a large temperature variation of the clock environment during use of the clock.

### SUMMARY

Disclosed is a novel method for determining skew measurements for clock errors in an autonomous ocean bottom seismic node. A parabolic fit may be used to estimate the clock drift of an ocean bottom seismic node during node deployment. Temperatures of the node may be measured real-time/continuously during node deployment. A temperature/frequency trend and a real time temperature measurement may be used to compute a temperature corrected parabolic trend. The temperature/frequency trend could be measured in a laboratory on a node by node basis or it could be a single trend that is suitable for all nodes.

The method may include measuring clock skew prior to node deployment and after node recovery, correcting the pre and post deployment skew measurements based on a temperature/frequency trend to a constant reference temperature, and computing a parabolic trend of the skew measurements of the clock based on the temperature corrected pre and post deployment skew measurements. The method may also include correcting the temperature corrected parabolic trend (at the constant reference temperature) to the skew at actual experiment temperature.

Disclosed is a method for modeling clock drift of a seismic node, in which the method may comprise determining a parabolic fit of clock skew measurements of a plurality of ocean bottom seismic nodes based on temperature measurements during operation of the ocean bottom seismic nodes.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates a chart comparing measured skew against a linear estimation of the skew using pre-deployment and post recovery skew measurements.

FIG. 2 illustrates a chart detailing the impact of temperature dependent frequency changes on the shape of the skew trend.

FIG. 3 illustrates one embodiment of a temperature corrected parabolic estimation method according to the present disclosure.

### DETAILED DESCRIPTION

Various features and advantageous details are explained more fully with reference to the non limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

The present disclosure provides a method for determining a parabolic fit for a clock skew of an autonomous seismic node at a variety of temperatures. As mentioned above, prior modeling techniques for skew adjustment do not adjust for temperature and do not use parabolic models. In one embodiment, the disclosure utilizes a temperature and/or frequency trend and a real-time temperature measurement to compute a temperature corrected parabolic trend. The temperature and/or frequency trend may be measured in a laboratory on a node by node basis or it may be a single trend that is suitable for all nodes of the particular survey.

### Parabolic Estimations of Clock Drift

One application for the present disclosure is for autonomous seismic nodes. As is known in the art, such autonomous seismic nodes are self-contained independent seismometers, and each seismic node generally includes one or more seismic sensors (e.g., geophone and hydrophone sensors), a data recording unit, a reference clock for time synchronization, and a power source, such as those nodes and internal components described in more detail at U.S. Pat. Nos. 9,494,700 and 9,523,780, incorporated herein by reference. As described herein, one type of clock used in ocean bottom seismic nodes (such as Applicant's MANTA node) is a regulated crystal oscillator. The oven controlled crystal oscillator (OCXO) design of the clock helps maintain the oscillator at a constant temperature and minimize the impact of temperature changes on the clock frequency.

As with all seismic acquisition systems, ocean bottom seismic nodes must accurately know the time of each individual recorded amplitude measurement. This is typically done through an atomic clock or crystal oscillator within or coupled to the seismic node. For example, a crystal oscillator is designed to oscillate at a pre-described frequency and provides a relative reference of the time of each sample during the deployment period of the ocean bottom node. Even though efforts are made to minimize the impact of temperature, the clock is still very temperature dependent. For example, the oscillation frequency of the crystal clock is sensitive to temperature changes. Temperature changes affect the clock screw, which makes it difficult to fit accurate trends to the clock for skew estimation purposes (such as a parabolic trend).

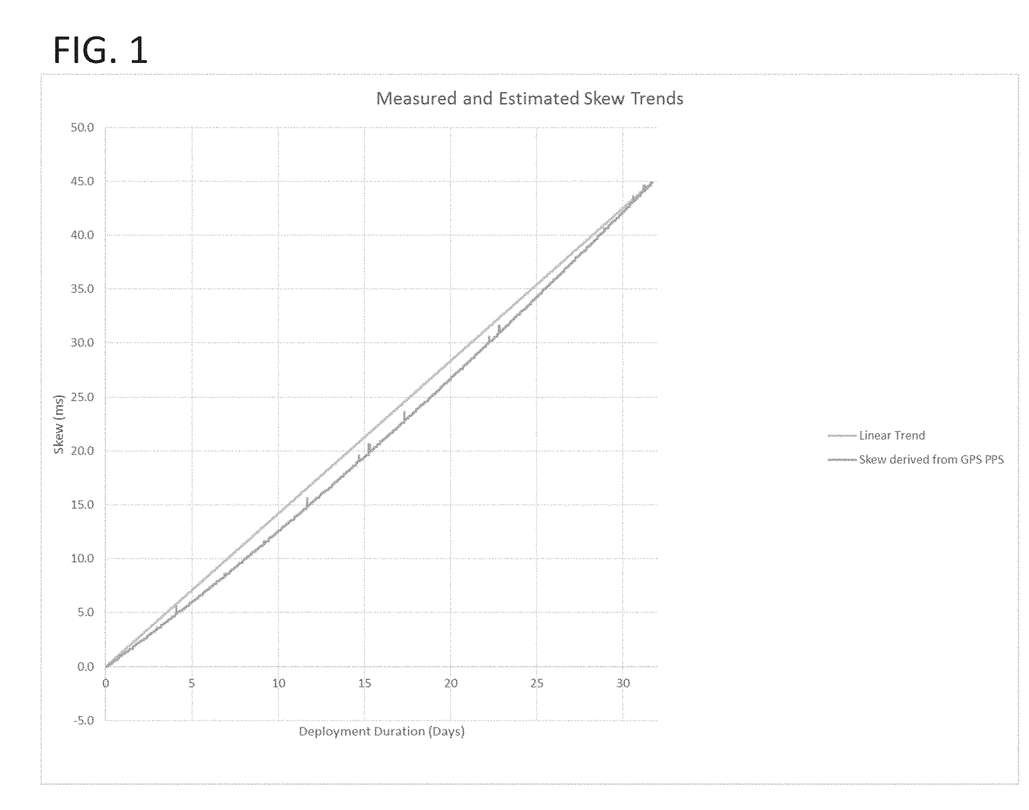

FIG. 1 illustrates a chart comparing measured skew against a linear estimation of the skew using pre-deployment and post recovery skew measurements. As seen from FIG. 1, at a constant temperature and assuming that the aging for a clock is linear, the frequency deviation is linear and the resulting timing skew is parabolic. Empirical testing conducted by the Applicant confirms that the skew is parabolic. Thus, an assumption of a linear fit, as is typically done for conventional skew estimation, does not optimally model the skew. Based on the present disclosure, however, it is possible to accurately estimate the parabolic trend from the pre-deployment and post recovery skew measurements. If the node is maintained at a constant temperature for the duration of the seismic experiment the parabolic estimation using pre-deployment and post recovery measurements may be used to determine skew corrections. Unfortunately, crystal oscillator frequency is temperature dependent and the normal ocean bottom node operational process includes large changes in temperature.

In one embodiment, the clock drift/skew (i.e., the change in clock error over time) can be modeled by the following formula:

$$Skew ( ms ) = [ \frac{{df}_{0}}{{f}_{nom}} + ( T - {T}_{ref} ) β ] t + \frac{1}{2} A \cdot {t}^{2} + C$$

where

f=frequency

T=Temperature

Tref=Reference Temperature (25° C.)

t=time since skew calibration (e.g., since the start of the test)

β=Temperature Coefficient (d(df/F))/dT)

A=Aging factor (assumes a constant for simplicity, i.e., the frequency changes linearly with time).

In deployment of ocean bottom nodes, the nodes and related operational process encounters large changes in the external temperature of the node. For example, as part of the offshore process the pre-deployment and post-recovery skew measurements are performed on the vessel at a very different temperature than the temperature the node is exposed to while deployed on the seafloor and/or in a water column for the duration of the experiment. This temperature/frequency dependence causes a distortion in the skew trend which makes it non-parabolic. Further, the change in oscillation frequency (d/t) temperature makes it impossible to accurately fit a parabolic trend to the pre-deployment and post recovery skew measurements without first compensating the measurements for temperature. The present disclosure provides methods for such temperature compensation.

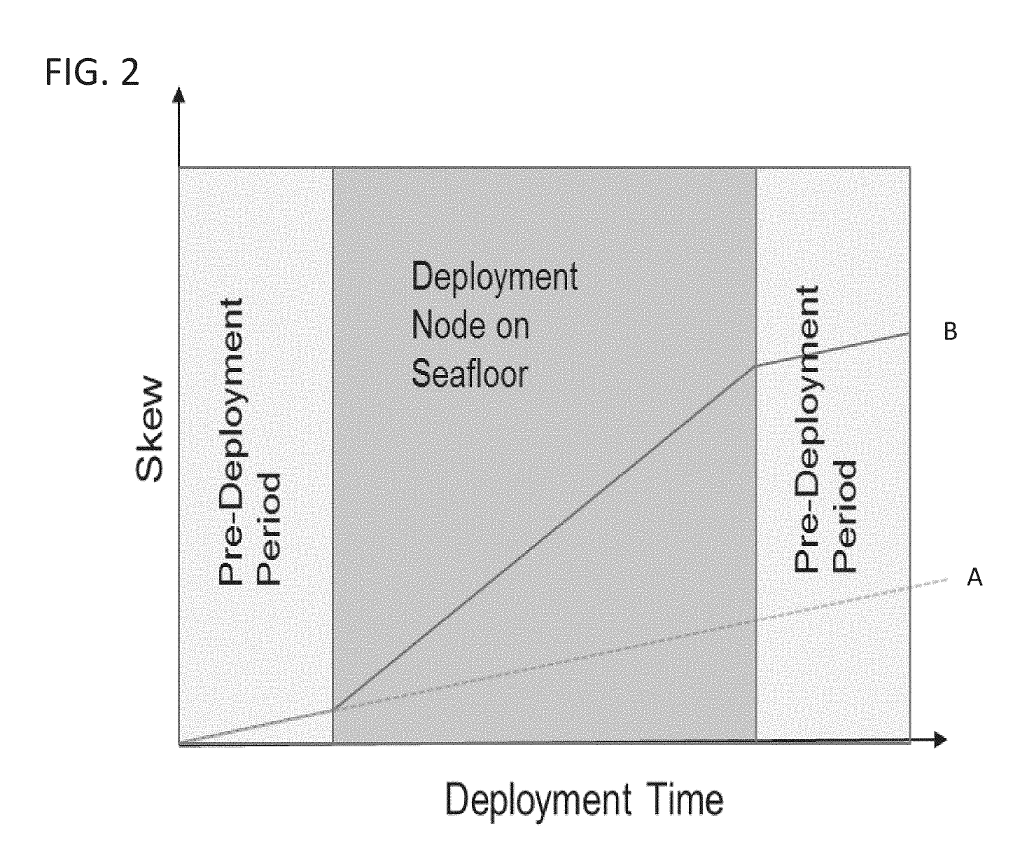

FIG. 2 is a chart illustrating the impact of temperature dependent frequency changes on the shape of the skew trend, assuming that the clock is linear (i.e., there is no aging component). FIG. 2 illustrates the skew for a deployment time of a seismic node (i.e., a skew/time curve).First line A shows skew at a constant temperature and second line B shows skew at a variable temperature. At constant temperature (see line A), the parabolic trend computation will estimate a straight line and thus frequency deviation will be constant for the full experiment. At variable temperatures (see line B), the change in temperature changes the gradient of the skew curve and thus makes it impossible to reliably fit a parabolic function to the data. Testing conducted by the Applicant for different clocks confirms this effect of variable temperatures on the skew/time curve. For clocks which have a very stable frequency with temperature, the parabolic trend estimation is very accurate (errors of less than 1 ms). However, when the temperature frequency dependence is higher, the parabolic estimation does not represent the true skew and results in errors which are larger in magnitude than that achieved with a linear correction.

Thus, a need exists for an improved method and system for modeling clock drift using a parabolic fit during applications where temperature varies during use of the clock.

### Temperature Corrected Parabolic Estimation

In one embodiment, the disclosure utilizes a temperature/frequency trend and a real-time temperature measurement to compute a temperature corrected parabolic trend. The temperature/frequency trend may be measured in a laboratory on a node by node basis or it may be a single trend that is suitable for all nodes for a particular survey.

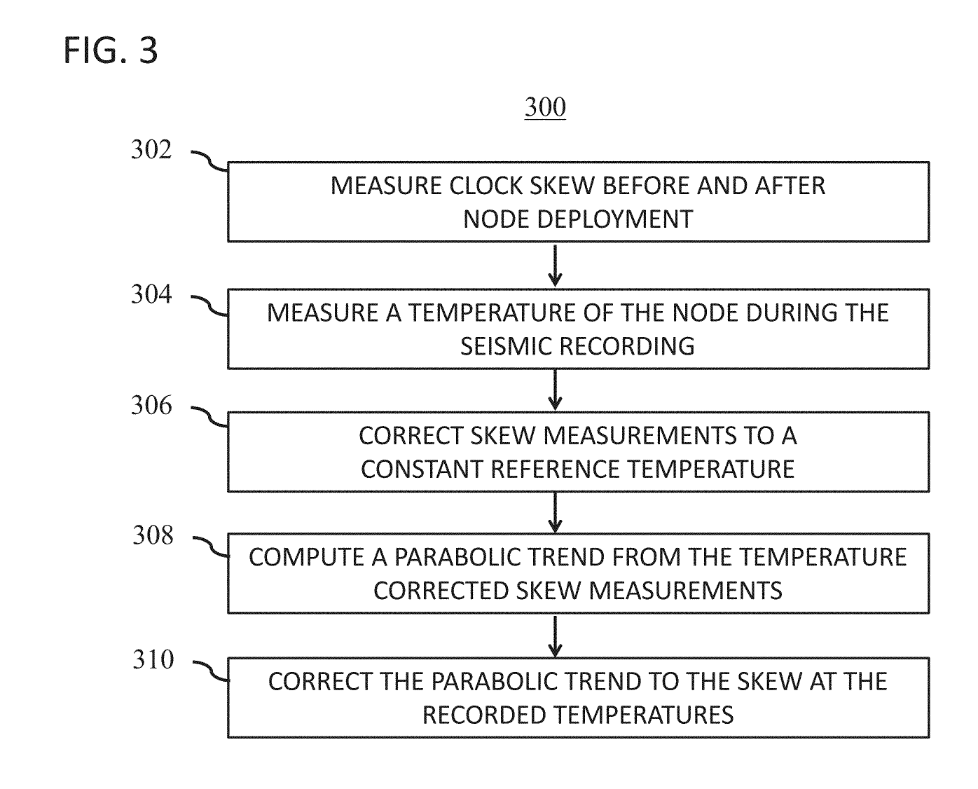

In one embodiment, the disclosed temperature corrected parabolic estimation method 300 (see FIG. 3) includes the following steps. First, as illustrated in block 302, method 300 comprises measuring skew immediately prior to node deployment and immediately after node recovery. For example, most nodes are deployed and recovered from a marine surface vessel, and the skew may be measured while the nodes are on board the vessel. Further, step 302 may be performed while the node is connected to an external reference clock. Still further, to accurately estimate the quadratic component of the skew it may be necessary to make multiple skew measurements over multiple minutes. Second, as illustrated in block 304, method 300 comprises measuring the temperature of the node throughout the seismic recording and/or other experiment. Regarding step 304, the temperature measurements may be performed continuously, real time, at various predetermined intervals, and/or estimated based on various temperature models. Third, as illustrated in block 306, method 300 comprises correcting the pre-deployment and post-recovery skew measurements to a constant reference temperature. Regarding step 306, the correction may be performed as if the node had been at a single reference temperature for the duration of the experiment. In one embodiment, the following formula is used for correction in step 306: Temp Adjusted Skew Measurement=Skewmeasured−∫ₜₒ^{t}[TFCF*(Tmeasured−Treference)dt], where t=time, T=temperature, and TFCF=temperature-frequency calibration factor. Fourth, as illustrated in block 308, method 300 comprises computing a parabolic trend from the temperature corrected pre-deployment and post recovery skew measurements (from step 306). In one embodiment, the computation of the parabolic trend is performed using well established techniques. Fifth, as illustrated in block 310, method 300 comprises correcting the parabolic trend to the skew at the recording temperature. In one embodiment, the following formula may be used for correcting the parabolic trend: TempAdjustedSkewEstimate(t)=ParabolicSkewEstimate(t)+∫ₜₒ^{t}[TFCF*(Tmeasured−Treference)dt], where t=time, T=temperature and TFCF=temperature-frequency calibration factor. One or more of these steps may be omitted.

In one embodiment, the temperature/frequency trend could be measured in a laboratory on a node by node basis or it could be a single trend that is suitable for all nodes for the particular seismic survey. In one embodiment, a factory or laboratory may calibrate the temperature dependence of the oscillation frequency of every node resulting in a temperature-frequency calibration factor (TFCF) for each node. This calibration may assume a linear relationship between frequency and temperature or it may assume a more complex relationship. In one embodiment, the TFCF may be archived in a database that is accessible during the node recovery, harvesting, and/or data-download process.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the disclosed method are within the scope of the invention. For example, the seismic node may be one deployed on the seabed or in other parts of the ocean or body of water. The clock may be located on an autonomous seismic node or other device. The described process may be utilized on any clock that is operated at a variety of temperatures and/or when the clock skew may change based on a variety of operational and/or temperature environments. The operation and/or environment temperature of the clock may be measured continuously, measured at predetermined intervals, and/or estimated based on various temperature models. It is emphasized that the foregoing embodiments are only examples of the very many different methods and uses that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for modeling clock drift of a seismic node, comprising
measuring clock skew prior to node deployment to determine pre-deployment skew measurements;
measuring clock skew after node recovery to determine post-recovery skew measurements;
correcting the pre-deployment skew measurements and the post-recovery skew measurements to a constant reference temperature;
computing a parabolic trend of clock skew measurements based on the temperature corrected pre-deployment and post-recovery skew measurements; and
correcting the parabolic trend to a variable experiment temperature.

2. The method of claim 1, further comprising
measuring a plurality of temperatures of the node during node deployment.

3. The method of claim 2, wherein the measuring step is performed continuously.

4. The method of claim 1, wherein the variable experiment temperature comprises a plurality of recorded node temperatures during deployment.

5. The method of claim 1, wherein correcting the pre-deployment and post-recovery skew measurements comprises using the following formula:
Temp Adjusted Skew Measurement=Skewmeasured−∫ₜₒ^{t}[TFCF*(Tmeasured−Treference)dt].

6. The method of claim 1, wherein correcting the parabolic trend step comprises using the following formula:
TempAdjustedSkewEstimate(t)=ParabolicSkewEstimate(t)+∫ₜₒ^{t}[TFCF*(Tmeasured−Treference)dt].

7. The method of claim 1, further comprising
performing each of these steps on a plurality of deployed nodes.

8. The method of claim 1, further comprising
performing each of these steps on a single node of a plurality of deployed nodes and using the computed parabolic trend for the plurality of deployed nodes.

9. A method for modeling clock drift of a seismic node, comprising
measuring clock skew prior to node deployment to determine pre-deployment skew measurements;
measuring clock skew after node recovery to determine post-recovery skew measurements;
measuring a plurality of temperatures of the node during node deployment; and
computing a parabolic trend of the skew measurements of the clock based on the measured temperatures.

10. The method of claim 9, further comprising
correcting the pre-deployment skew measurements and the post-recovery skew measurements to a constant reference temperature.

11. The method of claim 10, further comprising
correcting the parabolic trend from the temperature corrected skew measurements.

12. A method for modeling clock drift of a seismic node, comprising
determining a parabolic fit of clock skew measurements of a plurality of ocean bottom seismic nodes based on temperature measurements during operation of the ocean bottom seismic nodes.

13. The method of claim 12, further comprising correcting the parabolic fit based on the temperature measurements.
